(19) United States
(12) Patent Application Publication
(10) Pub. No.: US 2023/0272140 A1
(43) Pub. Date: Aug. 31, 2023

(54) COMPOSITION FOR SEALING COATED ELECTRIC WIRE, AND COATED ELECTRIC WIRE

(71) Applicant: TOAGOSEI CO., LTD., Minato-ku, Tokyo (JP)

(72) Inventors: Akira TAKAGI, Nagoya-shi, Aichi (JP); Tatsuya NAKAYASU, Nagoya-shi, Aichi (JP); Hiroyuki TERAI, Nagoya-shi, Aichi (JP)

(21) Appl. No.: 18/003,506

(22) PCT Filed: Jul. 1, 2021
(86) PCT No.: PCT/JP2021/024960

§ 371 Date: Dec. 28, 2022

(30) Foreign Application Priority Data
Jul. 1, 2020 (JP) 2020-114493

(51) Int. Cl. C08F 222/32; C08L 33/10; C08J 3/28

(52) U.S. Cl. CPC C08F 222/32; C08L 33/10; C08J 3/28; C08L 2203/206

(57) ABSTRACT

There are provided a composition for sealing a coated electric wire, containing a 2-cyanoacrylate compound, which gives a cured product not only excellent in heat resistance, moisture heat resistance, and thermal shock resistance but also excellent in flex resistance, wherein the 2-cyanoacrylate compound contains more than 50 mass % to not more than 99 mass % of a 2-cyanoacrylate having an ether bond in an ester residue, and not less than 1 mass % to less than 50 mass % of at least one alkyl 2-cyanoacrylate selected from a group consisting of isopropyl cyanoacrylate and n-butyl cyanoacrylate, relative to 100 mass % of the total of the 2-cyanoacrylate compound; and further a coated electric wire covered by the composition.

### TECHNICAL FIELD

The present invention relates to a composition for sealing a coated electric wire, containing a cyanoacrylate compound, and a coated electric wire. More particularly, the present invention relates to a composition widely utilized as a sealing agent for coated electric wires in the wiring of the various types of electrical systems of automobiles, home electric appliances, office automation (OA) equipment and the like, and various types of outdoor and indoor wiring, and also relates to a coated electric wire covered by the composition.

### BACKGROUND ART

In automobiles, home electric appliances, OA equipment and the like, various types of electrical systems are wired by electric wires, and for their wiring, coated electric wires are used. For the coated electric wires, there have been cases where gas and moisture enter the gap between the conducting wire and the coating, the conducting wire itself breaks due to corrosion, and further a precision component coupled to the electric wire is deteriorated to cause the malfunction of the equipment.

In order to avoid these troubles, conventionally, a method is adopted in which a composition for sealing a coated electric wire is provided in the boundary portion between the coated portion of a coated electric wire and the exposed portion to fill and fix the gap to enhance airtightness. As such a composition for sealing a coated electric wire, one described in Patent Literature 1 or 2 is already known.

Patent Literature 1 describes a composition for sealing a coated electric wire, including an alkyl-2-cyanoacrylate, a 2-cyanoacrylate having an ether bond in the ester residue, and a (meth)acrylate having two or more (meth)acryloyloxy groups.

Patent Literature 2 describes a composition for sealing a coated electric wire, containing a 2-cyanoacrylate including 10 mass % or more of an alkyl-2-cyanoacrylate having an alkyl group with 4 or more carbon atoms in the main chain.

### CITATION LIST

### Patent Literature

Patent Literature 1: Japanese Patent Laid-Open No. 9-118839
Patent Literature 2: International Publication No. WO 2018/216737

### SUMMARY OF INVENTION

It is an object of the present invention to provide a composition for sealing a coated electric wire which gives a cured product not only excellent in heat resistance, moisture heat resistance, and thermal shock resistance but also excellent in flex resistance, and a coated electric wire covered by the composition.

According to one aspect of the present invention, the present invention provides a composition for sealing a coated electric wire, comprising a 2-cyanoacrylate compound, wherein the 2-cyanoacrylate compound comprises more than 50 mass % to not more than 99 mass % of a 2-cyanoacrylate having an ether bond in an ester residue thereof, and not less than 1 mass % to less than 50 mass % of at least one alkyl 2-cyanoacrylate selected from a group consisting of isopropyl cyanoacrylate and n-butyl cyanoacrylate, relative to 100 mass % of the total of the 2-cyanoacrylate compound.

According to an embodiment of the present invention, the composition of the present invention causes no fracture or crack to occur in the coated electric wire when a tip side of the coated electric wire is sealed with a cured product of the composition and wound around a mandrel having a diameter of 2 mm in accordance with JIS K5600-5-1 (1999), in which the coated electric wire has a conductor portion of 2.5 mm in diameter obtained by twisting 30 copper wires and is coated thereon with polyvinyl chloride to have an outer diameter of 3.5 mm.

According to another embodiment of the present invention, a storage modulus of the cured product of the composition of the present invention at 23° C. is not less than 0.5×10⁵ Pa to not more than 5.0×10⁷ Pa.

According to another embodiment of the present invention, the composition of the present invention further comprises a (meth)acrylate having two or more (meth)acryloyloxy groups in one molecule.

According to still another embodiment of the present invention, the composition of the present invention further comprises at least one selected from a group consisting of a polymerization initiator, a curing accelerator, and a colorant.

According to still another embodiment of the present invention, the composition of the present invention comprises not less than 10 ppm to not more than 30000 ppm of a crown ether as the curing accelerator.

According to another aspect, the present invention provides a coated electric wire comprising a cured product of the composition for sealing a coated electric wire according to the present invention.

According to still another aspect, the present invention provides a method for making a sealed coated electric wire, comprising coating an exposed portion of a coated electric wire and a periphery thereof with the composition for sealing a coated electric wire according to the present invention, and curing the composition.

According to the present invention, there are provided a composition for sealing a coated electric wire which gives a cured product not only excellent in heat resistance, moisture heat resistance, and thermal shock resistance but also excellent in flex resistance, and a coated electric wire comprising the cured product of the composition for sealing a coated electric wire.

### DESCRIPTION OF EMBODIMENTS

Embodiments of the present invention will be described below, but the present invention is not limited to these.

As used herein, “(meth)acryl” means both or either one of acryl and methacryl, “(meth)acryloyl” means both or either one of acryloyl and methacryloyl, and “(meth)acrylate” means both or either one of acrylate and methacrylate.

### 1. 2-Cyanoacrylate Compound

A composition for sealing a coated electric wire according to the present invention contains a 2-cyanoacrylate compound as the main adhesive component.

The composition for sealing a coated electric wire according to the present invention contains, as the 2-cyanoacrylate compound, a 2-cyanoacrylate having an ether bond in the ester residue as the main component, and in addition to this, at least one alkyl 2-cyanoacrylate selected from the group consisting of isopropyl cyanoacrylate and n-butyl cyanoacrylate.

### 1-1. 2-Cyanoacrylate Having Ether Bond in Ester Residue

Examples of the 2-cyanoacrylate having an ether bond in the ester residue include alkoxyalkyl-2-cyanoacrylates and 2-cyanoacrylates of cyclic alkyl ethers.

In the present invention, the “ester residue” is the moiety in the compound other than the ester bond, that is, the moiety represented by —R of the group represented by —CO—O—R ester-bonded to the 2-cyanoacrylate.

As the alkoxyalkyl-2-cyanoacrylates, those in which the number of carbon atoms of the alkoxyalkyl group is 2 to 12 are preferred, those in which the number of carbon atoms of the alkoxyalkyl group is 2 to 10 are more preferred, and those in which the number of carbon atoms of the alkoxyalkyl group is 2 to 8 are still more preferred. Specific examples of the alkoxyalkyl-2-cyanoacrylates include methoxyethyl-2-cyanoacrylate, ethoxyethyl-2-cyanoacrylate, propoxyethyl-2-cyanoacrylate, isopropoxyethyl-2-cyanoacrylate, butoxyethyl-2-cyanoacrylate, hexyloxyethyl-2-cyanoacrylate, 2-ethylhexyloxyethyl-2-cyanoacrylate, butoxyethoxyethyl-2-cyanoacrylate, hexyloxyethoxyethyl-2-cyanoacrylate, 2-ethylhexyloxyethoxyethyl-2-cyanoacrylate, methoxypropyl-2-cyanoacrylate, methoxypropoxypropyl-2-cyanoacrylate, methoxypropoxypropoxypropyl-2-cyanoacrylate, ethoxypropyl-2-cyanoacrylate, and ethoxypropoxypropyl-2-cyanoacrylate.

Specific examples of the 2-cyanoacrylates of cyclic alkyl ethers include tetrahydrofurfuryl-2-cyanoacrylate.

One 2-cyanoacrylate having an ether bond in the ester residue may be used alone, or two or more 2-cyanoacrylates having an ether bond in the ester residue may be used in combination.

Among these, alkoxyethyl-2-cyanoacrylates in which the number of carbon atoms of the alkoxy group is 1 to 8, such as methoxyethyl-2-cyanoacrylate, ethoxyethyl-2-cyanoacrylate, and butoxyethyl-2-cyanoacrylate, are preferably used because of easy availability and excellent stability, and ethoxyethyl-2-cyanoacrylate is particularly preferred.

In the composition for sealing a coated electric wire according to the present invention, the content of the 2-cyanoacrylate having an ether bond in the ester residue is more than 50 mass % and 99 mass % or less, preferably 51 mass % or more and 99 mass % or less, more preferably in the range of 60 mass % or more and 95 mass % or less, and still more preferably 65 mass % or more and 95 mass % or less, with the total of the 2-cyanoacrylate compound being 100 mass %. When the content of the 2-cyanoacrylate having an ether bond in the ester residue is more than 50 mass %, the elastic modulus of the composition for sealing a coated electric wire is not too high, and the flex resistance is good, and the heat resistance, the moisture heat resistance, and the thermal shock resistance are also good. When the content of the 2-cyanoacrylate having an ether bond in the ester residue is 99 mass % or less, the thermal shock resistance of the composition for sealing a coated electric wire is good.

### 1-2. Alkyl 2-Cyanoacrylate

The composition for sealing a coated electric wire according to the present invention contains, as the 2-cyanoacrylate compound, at least one alkyl 2-cyanoacrylate selected from the group consisting of isopropyl cyanoacrylate and n-butyl cyanoacrylate, in addition to the 2-cyanoacrylate having an ether bond in the ester residue. One of these two alkyl 2-cyanoacrylates may be used alone, or two of these two alkyl 2-cyanoacrylates may be used in combination.

In the composition for sealing a coated electric wire according to the present invention, the content of the two alkyl 2-cyanoacrylates is 1 mass % or more and less than 50 mass %, preferably 1 mass % or more and 49 mass % or less, more preferably 5 mass % or more and 40 mass % or less, and still more preferably 5 mass % or more and 35 mass % or less, with the total of the 2-cyanoacrylate compound being 100 mass %. When the content of the two alkyl 2-cyanoacrylates is less than 50 mass %, the elastic modulus of the composition for sealing a coated electric wire is not too high, and the flex resistance is good, and the heat resistance, the moisture heat resistance, and the thermal shock resistance are also good. When the content of the alkyl 2-cyanoacrylates is 1 mass % or more, the thermal shock resistance of the composition for sealing a coated electric wire is good.

The composition for sealing a coated electric wire according to the present invention may contain another alkyl 2-cyanoacrylate compound other than the above, as an alkyl 2-cyanoacrylate compound, as long as the object of the present invention is not impaired.

Examples of such another 2-alkyl cyanoacrylate compound include methyl-2-cyanoacrylate, ethyl-2-cyanoacrylate, n-propyl-2-cyanoacrylate, 2-butyl-2-cyanoacrylate, isobutyl-2-cyanoacrylate (2-methylpropyl-2-cyanoacrylate), n-hexyl-2-cyanoacrylate, n-heptyl-2-cyanoacrylate, 1-methylpentyl-2-cyanoacrylate, n-octyl-2-cyanoacrylate, 2-octyl-2-cyanoacrylate, 2-ethylhexyl-2-cyanoacrylate, n-nonyl-2-cyanoacrylate, isononyl-2-cyanoacrylate, n-decyl-2-cyanoacrylate, isodecyl-2-cyanoacrylate, n-undecyl-2-cyanoacrylate, and n-dodecyl-2-cyanoacrylate. One of these may be used alone, or two or more of these may be used in combination.

The content of the entire 2-cyanoacrylate compound in the composition for sealing a coated electric wire according to the present invention is preferably 50 mass % or more, more preferably 65 mass % to 90 mass %, with respect to the total mass of the composition for sealing a coated electric wire, from the viewpoint of easily setting the storage modulus of the cured product within a predetermined range described later, without impairing the curing rate.

### 2. (Meth)Acrylate Having Two or More (Meth)Acryloyloxy Groups in One Molecule

The composition for sealing a coated electric wire according to the present invention can contain a (meth)acrylate having two or more (meth)acryloyloxy groups in one molecule for provision of heat resistance and flexibility in the obtained cured product.

As the (meth)acrylate having two or more (meth)acryloyloxy groups in one molecule, various ones can be used, but those containing no functional group such as an amino group that may adversely affect the stability of the composition and the adhesiveness of the 2-cyanoacrylate compound are preferred. The upper limit of the number of (meth)acryloyloxy groups in one molecule is not particularly limited and can be, for example, 6 or less.

Examples of (meth)acrylates having two (meth)acryloyloxy groups in one molecule include ethylene glycol di(meth)acrylate (examples of commercial products include NK Ester 1G (trade name, manufactured by Shin Nakamura Chemical Co., Ltd.), the same applies below), polyethylene glycol di(meth)acrylate (acrylate: ARONIX M-240 (trade name, manufactured by Toagosei Co., Ltd.) and the like, methacrylate: NK Ester 4G, 9G, 14G, and 23G (trade names, manufactured by Shin Nakamura Chemical Co., Ltd.) and the like), tripropylene glycol di(meth)acrylate (ARONIX M-220 (trade name, manufactured by Toagosei Co., Ltd.) and the like), neopentyl glycol di(meth)acrylate (Light Acrylate NP-A (trade name, manufactured by Kyoeisha Chemical Co., Ltd.) and the like), 1,6-hexanediol di(meth)acrylate (Light Acrylate 1.6HX-A (trade name, manufactured by Kyoeisha Chemical Co., Ltd.) and the like), the ethylene oxide-modified di(meth)acrylate of bisphenol A (ARONIX M-211B (trade name, manufactured by Toagosei Co., Ltd.) and the like), 3-(meth)acryloyloxyglycerin mono(meth)acrylate (Light Acrylate G-201P (trade name, manufactured by Kyoeisha Chemical Co., Ltd.) and the like), hydrogenated dicyclopentadienyl di(meth)acrylate (Light Acrylate DCP-A (trade name, manufactured by Kyoeisha Chemical Co., Ltd.) and the like), a polyester (meth)acrylate represented by the following formula (A) (KAYARAD HX-220 and 620 (trade names, manufactured by Nippon Kayaku Co., Ltd.) and the like), urethane (meth)acrylates (ARONIX M-1100 and 1200 (trade names, manufactured by Toagosei Co., Ltd.) and the like), and a bisphenol A-diepoxy-(meth)acrylic acid adduct (Viscoat #540 (trade name, manufactured by OSAKA ORGANIC CHEMICAL INDUSTRY LTD.) and the like).

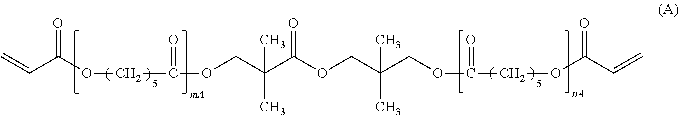

In the above formula (A), the average value of mA+nA is 2 to 4.

Examples of (meth)acrylates having three (meth)acryloyloxy groups in one molecule include pentaerythritol tri(meth)acrylate (ARONIX M-305 (trade name, manufactured by Toagosei Co., Ltd.) and the like), trimethylolpropane tri(meth)acrylate (ARONIX M-309 (trade name, manufactured by Toagosei Co., Ltd.) and the like), trimethylolpropane propylene oxide-modified tri(meth)acrylate (ARONIX M-321 (trade name, manufactured by Toagosei Co., Ltd.) and the like), and trimethylolpropane tri(meth)acrylate (NK Ester A-TMPT and TMPT (trade names, manufactured by Shin Nakamura Chemical Co., Ltd.) and the like).

(Meth)acrylates having four (meth)acryloyloxy groups in one molecule include pentaerythritol tetra(meth)acrylate (ARONIX M-450 (trade name, manufactured by Toagosei Co., Ltd.) and the like). Examples of (meth)acrylates having five (meth)acryloyloxy groups in one molecule include dipentaerythritol penta(meth)acrylate. Examples of (meth)acrylates having six (meth)acryloyloxy groups in one molecule include dipentaerythritol hexa(meth)acrylate (KAYARAD DPHA (trade name, manufactured by Nippon Kayaku Co., Ltd.)) and dipentaerythritol propylene oxide-modified hexa(meth)acrylate (KAYARAD DPCA-20, 30, 60, and 1209 (trade names, manufactured by Nippon Kayaku Co., Ltd.)).

One of these may be used alone, or two or more of these can also be used in combination.

Among these, the acrylate represented by the formula (A), polyethylene glycol di(meth)acrylate and/or polypropylene glycol di(meth)acrylate, and the like are preferably used because the obtained cured product has moderate flexibility.

The content of the (meth)acrylate having two or more (meth)acryloyloxy groups in one molecule is preferably 50 mass % or less, more preferably 10 mass % to 35 mass % with respect to the total mass of the composition for sealing a coated electric wire, from the viewpoint of the water resistance and thermal shock resistance of the obtained cured product.

### 3. Polymerization Initiator

The composition for sealing a coated electric wire according to the present invention may contain a polymerization initiator.

Particularly, in a mode in which the composition of the present invention contains the (meth)acrylate component having two or more (meth)acryloyloxy groups in one molecule, the composition preferably contains a radical polymerization initiator for accelerating the polymerization of the (meth)acrylate component.

Examples of the polymerization initiator preferably include thermal polymerization initiators, more preferably thermal radical polymerization initiators.

Examples of the radical polymerization initiators include organic peroxides such as hydroperoxides, peroxyesters, ketone peroxides, peroxyketals, dialkyl peroxides such as di-t-butyl hydroperoxide, diacyl peroxides, and peroxydicarbonates.

The content of the polymerization initiator is preferably 0.1 mass % to 1 mass %, more preferably 0.3 mass % to 0.6 mass %, with respect to the total mass of the composition of the present invention from the viewpoint of storage stability.

### 4. Curing Accelerator

The composition for sealing a coated electric wire according to the present invention may contain a curing accelerator for the 2-cyanoacrylate compound.

As the curing accelerator, various types of polymerization accelerators can be used, but anionic polymerization accelerators are preferred.

Examples of the anionic polymerization accelerators include polyalkylene oxides and derivatives thereof, crown ethers and derivatives thereof, silacrown ethers and derivatives thereof, and calixarene derivatives, and among these, crown ethers are preferred.

When the curing accelerator is a crown ether, their content is preferably 10 ppm or more and 30000 ppm or less with respect to the total mass of the composition of the present invention from the viewpoint of storage stability.

### 5. Other Components

The composition for sealing a coated electric wire according to the present invention may contain other components in addition to the above components. Examples of other components include known additives, specifically a thickener, a plasticizer, a stabilizer, a colorant, a diluent, and a filler (silica particles and the like).

The content of other components is not particularly limited but is preferably 20 mass % or less, more preferably 10 mass % or less, with respect to the total mass of the composition of the present invention.

As the stabilizer, known polymerization retarders and polymerization inhibitors can be used, and examples thereof include hydroquinone and sulfurous acid gas.

Examples of the colorant include dyes and pigments, and those used for the coloration of coating materials for the electric wires of coated electric wires, for example, those described in Japanese Patent Laid-Open No. 2016-011366, can be used.

### 6. Physical Properties of Composition for Sealing Coated Electric Wire

The composition for sealing a coated electric wire according to the present invention provides a cured product not only excellent in heat resistance, moisture heat resistance, and thermal shock resistance but also excellent in flex resistance. This flex resistance of the cured product specifically means flex resistance at a level at which when the tip side of a coated electric wire obtained by sealing the tip with the cured product of the composition for sealing a coated electric wire according to the present invention is wound around a mandrel having a diameter of 2 mm in accordance with JIS K5600-5-1 (1999), no fracture or crack occurs in the coated electric wire. Here, the coated electric wire means one obtained by coating a conductor portion having a diameter of 2.5 mm obtained by twisting 30 copper wires with polyvinyl chloride so that the outer diameter is 3.5 mm. JIS K5600-5-1 (1999) corresponds to the International Organization for Standardization ISO 1519 (1973).

The cured product of the composition for sealing a coated electric wire according to the present invention preferably has a storage modulus of 0.5×10⁵ Pa or more and 5.0×10⁷ Pa or less at 23° C. When the storage modulus of the cured product is equal to or more than the lower limit value, the resistance to brittle fracture is good, and when the storage modulus of the cured product is equal to or less than the upper limit value, the toughness is good. This is preferred because the flex resistance, heat resistance, moisture heat resistance, and thermal shock resistance of the cured product are good.

According to the present invention, the flex resistance and storage modulus can be achieved by blending the 2-cyanoacrylate having an ether bond in the ester residue, and at least one alkyl 2-cyanoacrylate selected from the group consisting of isopropyl cyanoacrylate and n-butyl cyanoacrylate, within the ranges of the predetermined amounts to constitute the 2-cyanoacrylate compound, and blending the (meth)acrylate having two or more (meth)acryloyloxy groups into the 2-cyanoacrylate compound constituted as described above, within the range of the predetermined amount, as needed.

### 7. Method of Use

The composition for sealing a coated electric wire according to the present invention can be used for various coated electric wires such as those in which one conducting wire is coated with an insulating coating, and those in which a twisted wire in which several conducting wires are twisted is coated with an insulating coating.

Specifically, by coating the exposed portion of a coated electric wire and the periphery thereof with the composition of the present invention, and curing the composition, the periphery of the exposed portion of the coated electric wire can be sealed.

As the coating method, various methods can be adopted, and examples thereof can include a method of applying or injecting the composition of the present invention to the exposed portion of a coated electric wire and the periphery thereof, or a method of immersing the exposed portion of a coated electric wire and the periphery thereof in the composition of the present invention.

As the method for curing the composition of the present invention coating the exposed portion of the coated electric wire and the periphery thereof, methods usually adopted for cyanoacrylate-based adhesives can be applied. Usually, the composition cures by the moisture in the air by standing, and when the curing rate is not sufficient, an anionic polymerization initiator, an amine, for example, N,N′-dimethylaniline or triethanolamine (commercial products include aa Accelerator (trade name, manufactured by Toagosei Co., Ltd.)), can also be sprayed on the coated portion to accelerate the curing.

The composition of the present invention is preferably prepared so as to have a viscosity at which this can easily penetrate the gap between a conducting wire and a coating to sufficiently seal the coated electric wire. The composition of the present invention preferably has a viscosity of 3 mPa·s to 120 mPa·s, more preferably 4 mPa·s to 60 mPa·s, and further preferably 5 mPa·s to 35 mPa·s at 25° C. The composition of the present invention preferably has such a viscosity because of excellent workability and also in that a method of immersing the exposed portion of a coated electric wire and the periphery thereof in the composition can be adopted.

More specifically, a conducting wire obtained by peeling off the coating of a coated electric wire is crimped with a particular component, and the exposed portion of this coated electric wire and the periphery thereof are immersed in the composition of the present invention. The time during which the exposed portion of the coated electric wire and the periphery thereof are immersed should be appropriately selected according to the type of the composition used but is usually about several seconds to 30 seconds.

This curing rate can be adjusted by adjusting the blending proportions of the above-described curing accelerator, polymerization retarder, and the like.

### 8. Coated Electric Wire

The coated electric wire of the present invention is a coated electric wire including a cured product of the composition for sealing a coated electric wire according to the present invention, preferably a coated electric wire sealed with a cured product of the composition for sealing a coated electric wire according to the present invention.

The composition for sealing a coated electric wire according to the present invention can be preferably used for sealing a portion where an electric wire is exposed, in a coated electric wire, particularly an end, splice portion, or the like of a coated electric wire, and can be more preferably used for sealing an electric wire exposed portion electrically connecting two or more coated electric wires.

The electric wire exposed portion may be an end or intermediate portion of a coated electric wire.

The composition for sealing a coated electric wire according to the present invention can also be preferably used for sealing in a connection portion between a coated electric wire and another member (a connector, a terminal, a protective tool, a forming tool, a fixture, a substrate, or the like).

The electric wire in the coated electric wire is not particularly limited, and known electric wires can be used. Examples of the material of the electric wire include copper, aluminum, and alloys thereof.

The electric wire may be a single wire or a plurality of wires but is preferably a plurality of wires.

The coating material in the coated electric wire is not particularly limited, and known coating materials can be used.

The coating material is preferably an insulating material.

The coating material preferably includes a resin, more preferably a thermoplastic resin.

The cross-sectional shape, length, coating thickness, and the like of the coated electric wire are not particularly limited and can be appropriately selected.

The coated electric wire of the present invention is not particularly limited, and examples thereof preferably include wire harnesses for automobiles, home electric appliances, OA equipment, and the like, particularly preferably wire harnesses for automobiles.

### EXAMPLES

The present invention will be specifically described below based on Examples. The present invention is not limited by these Examples. In the following, “parts” and “%” mean “parts by mass” and “mass %” respectively unless otherwise noted.

### Method for Measuring Storage Modulus of Cured Product of Composition for Sealing Coated Electric Wire at 23° C.

Measurement was performed as follows using MCR301 manufactured by AntonPaar.

A curing accelerator solution (an ethanol solution of 5 mass % of N,N′-dimethyl para-toluidine) was applied to both surfaces of upper and lower parallel plates and dried, then an appropriate amount of a composition was applied to the lower plate, and the upper plate was immediately lowered. Subsequently, the composition was left to stand at 25° C. for 2 hours, and the storage modulus at 23° C. was measured under the conditions of a strain of 0.1%, a frequency of 1 Hz, a temperature increase rate of 2° C./minute, and an initial gap of 300 μm.

### Examples 1 to 9 and Comparative Examples 1 to 7

Components shown in Table 1 were mixed in a blending proportion shown in Table 1 by an ordinary method to prepare a composition for sealing a coated electric wire.

### Evaluation

For the obtained compositions for sealing coated electric wires, the following evaluation was performed. Their results are shown in Table 1.

### Electric Wire Sealing Property Test (Moisture Heat Test, Thermal Shock Test, and Heat Resistance Test)

The coating polyvinyl chloride of a soft polyvinyl chloride-coated conducting wire (the diameter of the conducting wire: the diameter of one in which 30 copper wires were twisted: 2.5 mm, the outer diameter of the coating polyvinyl chloride: 3.5 mm) was peeled off by 15 mm from a tip, and 30 mm of the coated conducting wire from the tip was immersed in a composition for sealing a coated electric wire for about 2 seconds, followed by aging under an atmosphere at 23° C. and a humidity of 50% for 1 or more days for curing.

For the sealed coated electric wire exposed to a moisture heat environment at 80° C. and a humidity of 95% RH for 50 hours, an electric wire sealing property test was performed (moisture heat test).

On the other hand, also for the sealed coated electric wire subjected to 100 cycles of thermal shock at −40° C. for 30 minutes to 120° C. for 30 minutes, the electric wire sealing property test was performed in the same manner as above (thermal shock test).

Further, also for the sealed coated electric wire exposed to 120° C. for 96 hours, the electric wire sealing property test was performed in the same manner as above (heat resistance test).

In the electric wire sealing property test, compressed air at the predetermined pressures shown below was fed from the side of the coated electric wire not subjected to sealing treatment, and the tip of the coated electric wire was immersed in water to confirm the presence or absence of air leakage.

An evaluation was made by A to E according to the airtight pressure at which air leakage occurred.
A: an airtight pressure of 0.5 kg/cm² or more
B: an airtight pressure of 0.3 kg/cm² or more and less than 0.5 kg/cm²
C: an airtight pressure of 0.1 kg/cm² or more and less than 0.3 kg/cm²
D: an airtight pressure of less than 0.1 kg/cm²

### Flex Test (Bending Resistance Test)

Each of the sealed coated electric wires was measured based on the description of flex resistance in JIS K5600-5-1 (1999) using the following apparatus, and visually evaluated by the following evaluation criteria. A fracture means a rupture in which the exposure of the electric wire of the coated electric wire can be visually confirmed, and a crack means a rupture that does not lead to a fracture but can be visually confirmed.

### <Test Apparatus>

Cylindrical mandrel flex tester manufactured by Allgood

Mandrel diameter: 2 mm Φ

### <Evaluation Criteria>

A: there is no fracture or crack
B: there is no fracture, and there is only a crack
C: there are both a fracture and a crack

TABLE 1

Composition

Curing
accel-

erator

| Cyanoacrylate compound (parts by mass) | | | | (Meth)acrylate | Polymerization | (ppm) | Colorant | Elastic |
|---|---|---|---|---|---|---|---|---|
| | Normal | Iso- | Ethoxy- | (parts by mass) | initiator | Dibenzo- | (ppm) | modulus |

| | Isopropyl- | butyl-2- | Ethyl-2- | butyl-2- | ethyl-2- | KAYA- | | (ppm) | | 18- | Kayaset | Kayaset | at | | Moisture | Thermal | Heat |
|---|---|---|---|---|---|---|---|---|---|---|---|---|---|---|---|---|---|
| | 2-cyano- | cyano- | cyano- | cyano- | cyano- | RAD HX- | M- | PER- | PER- | crown- | Red | Blue | 23° C. | Flex | heat | shock | resistance |
| | acrylate | acrylate | acrylate | acrylate | acrylate | 620 | 321 | BUTYL Z | CUMYL H | 6-ether | B | A-2R | (Pa) | test | test | test | test |
| Example | 10 | | | | 90 | | 20 | 5000 | 5000 | | 300 | | 2.5 × | A | A | B | A |
| 1 | | | | | | | | | | | | | 10⁷ | | | | |
| Example | 20 | | | | 80 | 25 | | 5000 | 5000 | 2000 | 300 | | 6.0 × | A | A | A | A |
| 2 | | | | | | | | | | | | | 10⁶ | | | | |
| Example | 30 | | | | 70 | | 30 | 5000 | 5000 | | | 300 | 6.1 × | A | A | A | A |
| 3 | | | | | | | | | | | | | 10⁶ | | | | |
| Example | 45 | | | | 55 | 50 | | 5000 | 5000 | 2000 | | 300 | 2.7 × | A | B | A | B |
| 4 | | | | | | | | | | | | | 10⁶ | | | | |
| Example | 10 | 10 | | | 80 | 25 | | 5000 | 5000 | | | | 6.3 × | A | A | A | A |
| 5 | | | | | | | | | | | | | 10⁶ | | | | |
| Example | 10 | 10 | | | 80 | 25 | | | | | | | 5.5 × | A | B | B | B |
| 6 | | | | | | | | | | | | | 10⁶ | | | | |
| Example | | 10 | | | 90 | 20 | | 5000 | | | 300 | | 6.4 × | A | A | B | A |
| 7 | | | | | | | | | | | | | 10⁶ | | | | |
| Example | | 20 | | | 80 | 30 | | 5000 | | 2000 | 300 | | 1.1 × | A | A | A | A |
| 8 | | | | | | | | | | | | | 10⁶ | | | | |
| Example | | 30 | | | 70 | | 50 | 5000 | 5000 | | | 300 | 0.8 × | A | B | B | B |
| 9 | | | | | | | | | | | | | 10⁵ | | | | |
| Comparative | | | 24 | | 60 | 36 | | 5000 | 5000 | | | | 6.3 × | C | D | D | D |
| Example | | | | | | | | | | | | | 10⁷ | | | | |
| 1 | | | | | | | | | | | | | | | | | |
| Comparative | | | 24 | | 72 | 24 | | 5000 | | | | | 7.2 × | C | D | C | D |
| Example | | | | | | | | | | | | | 10⁷ | | | | |
| 2 | | | | | | | | | | | | | | | | | |
| Comparative | | | 40 | | 60 | 5 | | 5000 | | | | | 1.0 × | C | C | D | C |
| Example | | | | | | | | | | | | | 10⁸ | | | | |
| 3 | | | | | | | | | | | | | | | | | |
| Comparative | | | 40 | | 60 | | 100 | 5000 | 5000 | | | | 1.2 × | A | D | D | D |
| Example | | | | | | | | | | | | | 10⁴ | | | | |
| 4 | | | | | | | | | | | | | | | | | |
| Comparative | 70 | | | | 30 | | | | | | | | 1.1 × | C | C | D | C |
| Example | | | | | | | | | | | | | 10⁸ | | | | |
| 5 | | | | | | | | | | | | | | | | | |
| Comparative | | | | 33 | 67 | 67 | | 5000 | 5000 | | | | 3.1 × | C | D | D | D |
| Example | | | | | | | | | | | | | 10⁴ | | | | |
| 6 | | | | | | | | | | | | | | | | | |
| Comparative | | | | 40 | 60 | | 5 | 5000 | | | | | 1.3 × | C | D | D | C |
| Example | | | | | | | | | | | | | 10⁸ | | | | |
| 7 | | | | | | | | | | | | | | | | | |

The details of the following terms in Table 1 are shown below.
KAYARAD HX-620: a trade name of the acrylate compound represented by the formula (A), wherein mA + nA = 4, manufactured by Nippon Kayaku Co., Ltd.
M-321: ARONIX M-321 (trade name) (trimethylolpropane propylene oxide-modified tri(meth)acrylate) manufactured by Toagosei Co., Ltd.
PERBUTYL Z: a trade name of di-t-butyl hydroperoxide, manufactured by NOF CORPORATION
PERCUMYL H: a trade name of an aromatic (cumene) hydroperoxide, manufactured by NOF CORPORATION
Kayaset Red B: Kayaset Red B (trade name) (anthraquinone-based coloring matter) manufactured by Nippon Kayaku Co., Ltd.
Kayaset Blue A-2R: Kayaset Blue A-2R (trade name) (C.I. Solvent Blue 83) manufactured by Nippon Kayaku Co., Ltd.

As shown in Table 1, for the compositions for sealing coated electric wires in Examples 1 to 9, the storage moduli of the cured products at 23° C. are in the range of 0.5×10⁵ Pa or more and 5.0×10⁷ Pa or less, and the obtained cured products are not only excellent in water resistance under high temperature and high humidity conditions, thermal shock resistance, and heat resistance but also excellent in flex resistance, compared with the compositions in Comparative Examples 1 to 7.

### INDUSTRIAL APPLICABILITY

The composition for sealing a coated electric wire according to the present invention is not only excellent in heat resistance, moisture heat resistance, and thermal shock resistance but also excellent in flex resistance and has good electric wire sealing properties, and therefore the composition can be widely utilized as an electric wire sealing agent for the wiring of the various types of electrical systems of automobiles, home electric appliances, OA equipment, and the like, and various types of outdoor and indoor wiring.

This application claims priority to Japanese Patent Application No. 2020-114493 filed Jul. 1, 2020, the entire disclosure of which is incorporated herein.

1. A composition for sealing a coated electric wire, comprising a 2-cyanoacrylate compound, wherein
the 2-cyanoacrylate compound comprises more than 50 mass % to not more than 99 mass % of a 2-cyanoacrylate having an ether bond in an ester residue thereof, and not less than 1 mass % to less than 50 mass % of at least one alkyl 2-cyanoacrylate selected from a group consisting of isopropyl cyanoacrylate and n-butyl cyanoacrylate, relative to 100 mass % of the total of the 2-cyanoacrylate compound.

2. The composition for sealing a coated electric wire according to claim 1, wherein no fracture or crack occurs in the coated electric wire when a tip side of the coated electric wire is sealed with a cured product of the composition and wound around a mandrel having a diameter of 2 mm in accordance with HS K5600-5-1 (1999), in which the coated electric wire has a conductor portion of 2.5 mm in diameter obtained by twisting 30 copper wires and is coated thereon with polyvinyl chloride to have an outer diameter of 3.5 mm.

3. The composition for sealing a coated electric wire according to claim 1, wherein a storage modulus of the cured product at 23° C. is not less than 0.5×10⁵ Pa to not more than 5.0×10⁷ Pa.

4. The composition for sealing a coated electric wire according to claim 1, further comprising a (meth)acrylate having two or more (meth)acryloyloxy groups in one molecule.

5. The composition for sealing a coated electric wire according to claim 1, further comprising at least one selected from a group consisting of a polymerization initiator, a curing accelerator, and a colorant.

6. The composition for sealing a coated electric wire according to claim 5, comprising not less than 10 ppm to not more than 30000 ppm of a crown ether as the curing accelerator.

7. A coated electric wire comprising a cured product of the composition for sealing a coated electric wire according to claim 1.

8. A method for making a sealed coated electric wire, comprising coating an exposed portion of a coated electric wire and a periphery thereof with the composition for sealing a coated electric wire according to claim 1, and curing the composition.

9. The composition for sealing a coated electric wire according to claim 2, wherein a storage modulus of the cured product at 23° C. is not less than 0.5×10⁵ Pa to not more than 5.0×10⁷ Pa.

10. The composition for sealing a coated electric wire according to claim 2, further comprising a (meth)acrylate having two or more (meth)acryloyloxy groups in one molecule.

11. The composition for sealing a coated electric wire according to claim 10, further comprising at least one selected from a group consisting of a polymerization initiator, a curing accelerator, and a colorant.

12. The composition for sealing a coated electric wire according to claim 11, further comprising not less than 10 ppm to not more than 30000 ppm of a crown ether as the curing accelerator.
